(19) United States
(12) Patent Application Publication
(10) Pub. No.: US 2026/0237077 A1
(43) Pub. Date: Aug. 13, 2026

(54) METHOD AND SYSTEM FOR TRAINING INSTANCE SEGMENTATION MODEL

(71) Applicants: Hyundai Motor Company, Seoul (KR); Kia Corporation, Seoul (KR)

(72) Inventors: Evan Ling, Singapore (SG); Keng Teck Ma, Singapore (SG); Zi Jian Yew, Singapore (SG)

(21) Appl. No.: 19/227,675

(22) Filed: Jun. 4, 2025

(30) Foreign Application Priority Data
Feb. 10, 2025 (KR) 10-2025-0016809

(51) Int. Cl. G06T 7/12

(52) U.S. Cl. CPC G06T 7/12

(57) ABSTRACT

An instance segmentation model training method includes applying image dataset to an instance segmentation model to thereby detect an instance mask, calculating a loss based on the detected instance mask and a ground truth (GT) instance mask corresponding to the image data, and updating the instance segmentation model based on the calculated loss, where the loss is calculated by applying a component-wise weight to a binary entropy loss calculation formula.

### CROSS REFERENCE TO RELATED APPLICATION

The present application claims priority to Korean Patent Application No. 10-2025-0016809, filed Feb. 10, 2025, the entire contents of which is incorporated herein for all purposes by this reference.

### TECHNICAL FIELD

The disclosure relates to instance segmentation model training, and more particularly, to a training method and system for implementing an instance segmentation model capable of ensuring equal loss contribution for different sized components that constitute a single instance.

### BACKGROUND

Instance segmentation involves detecting distinct instances within an image and segmenting the pixels associated with each instance.

In images with complex environments, instance segmentation emphasizes handling occlusion between instances.

Complex environments may feature closely located or overlapping instances.

Instance segmentation in such environments with overlapping instances is known as occluded instance segmentation.

Instance segmentation finds broad applications in various fields, including security, industry, and retail, where occlusion scenarios are common, making the resolution of occluded instance segmentation crucial.

Occluded instance segmentation is a highly challenging computer vision problem, with extensive research focused on developing effective models.

An ideal instance segmentation algorithm should accurately segment each instance pixel (accuracy), recognize all components related to a single instance as the same instance (completeness), and disregard ambiguous situations such as reflections or crowd blobs (uncertainty).

Current instance segmentation models often prioritize accuracy while neglecting completeness and uncertainty handling. However, completeness is particularly vital for safety applications.

For example, in collaborative robots (cobots) that operate alongside humans in shared workplaces, incomplete instance segmentation of human body parts can lead to severe injuries or fatalities.

Existing models use losses applied uniformly across the entire instance, such as binary cross-entropy (BCE) loss. This approach favors predicting large components but inherently overlooks semantically important small components.

Therefore, there is a need for an instance segmentation method that effectively applies the training loss to both large and small components.

### SUMMARY

The present disclosure is directed to a method for applying training loss effectively to both large and small components during instance segmentation.

The present disclosure is also directed to a component-balance focal (CBF) loss calculation method that applies loss by focusing on the components of an instance.

The present disclosure is also directed to a training method and a system for implementing an instance segmentation model that is capable of ensuring equal loss contribution for differently sized components constituting an instance.

The present disclosure is also directed to a training method and system for implementing an instance segmentation model that is capable of improving completeness in instance segmentation.

The present disclosure is also directed to a training method and a system for implementing an instance segmentation model that is capable of ensuring equal loss contribution for differently sized components constituting an instance.

According to one aspect of the subject matter described in this application, an instance segmentation model training method can include applying image data to the instance segmentation model to thereby detect an instance mask, calculating a loss based on the detected instance mask and a ground truth (GT) instance mask corresponding to the image data, and updating the instance segmentation model based on the calculated loss, where the loss can be calculated by applying a component-wise weight to a binary entropy loss calculation formula.

In some implementations, the weight can be set based on a proportion of a component in the mask. In some implementations, the weight may not be applied to an area corresponding to a background and can be applied to an area corresponding to a component of an instance. In some implementations, the loss can be calculated based on an entire mask or sampled points.

According to another aspect of the subject matter described in this application, an instance segmentation model training system can include a first database configured to store an image dataset, a second database configured to store a ground truth (GT) instance mask set corresponding to the image dataset, and a processor. The processor can be configured to apply image data to the instance segmentation model to thereby detect an instance mask, calculate a loss based on the detected instance mask and a GT instance mask corresponding to the image data, and update the instance segmentation model based on the calculated loss, where the loss is calculated by applying a component-wise weight to a binary entropy loss calculation formula.

In some implementations, the processor may not apply the weight to an area corresponding to a background and can apply the weight to the points of an area corresponding to a component of an instance. In some implementations, the processor can calculate the loss based on an entire mask or sampled points.

According to implementations of the features described in this application, a method in instance segmentation to effectively apply the training loss to both large and small components can provide technical benefits.

For example, the features can be advantageous in providing a component-balance focal (CBF) loss calculation method to apply loss with a focus on the components of an instance.

The features can also be advantageous in providing a training method and system for implementing an instance segmentation model ensuring equal loss contribution for different sized components constituting an instance.

The features can also be advantageous in terms of improving completeness in instance segmentation and instance segmentation performance for both large and small components by training an instance segmentation model using CBF loss.

### BRIEF DESCRIPTION OF THE DRAWINGS

FIG. 1 is a diagram illustrating an example of an instance segmentation model training system.

FIG. 2 is a flowchart illustrating an example of an instance segmentation model training method.

FIG. 3 is a graph representing an example of the component-level recall relative to the ratio of component area to instance area.

FIG. 4 is a diagram illustrating an example of a comparison between the training results of the instance segmentation model and the existing instance segmentation model with the ground truth (GT) instance mask.

### DETAILED DESCRIPTION

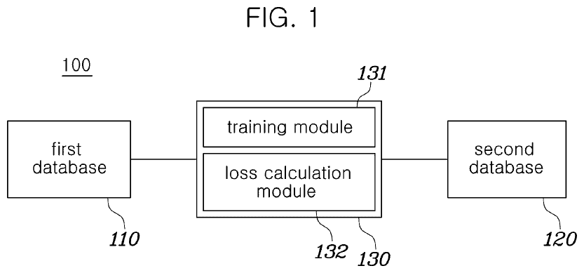

FIG. 1 is a diagram illustrating an example of an instance segmentation model training system 100.

With reference to FIG. 1, the instance segmentation model training system 100 (hereinafter referred to as the “system”) can provide a component-balance focal loss calculation method that applies loss with a focus on the components of an instance.

In some implementations, the system 100 can train an instance segmentation model to ensure equal loss contribution for different-sized components constituting a single instance.

In some implementations, the system 100 can include a first database 110, a second database 120, and a processor 130, and the configuration of the system 100 is not limited thereto.

In some implementations, the first database 110 can store a plurality of image data used for training the instance segmentation model.

Hereinafter, the plurality of image data used for training is referred to as the image dataset.

For example, the image dataset can include large-scale open-source datasets, and the data including the image dataset is not limited to open-source datasets.

In some implementations, the second database 120 can store ground truth (GT) data corresponding to the image dataset stored in the first database 110.

For example, the ground truth data can refer to the desired answers that the instance segmentation model aims to predict, and the performance of the instance segmentation model can be considered excellent when its output matches the ground truth data with high accuracy.

For example, the ground truth data can be labeled and stored in the second database 120, and the plurality of ground truth data stored in the second database 120 can refer to the ground truth dataset.

For example, e the ground truth dataset can include instances that serve as a reference for comparing the segmentation results for instances included in the image data stored in the first database 110.

Hereinafter, the output of the instance segmentation model may refer to the detected instance mask, and instances stored in the second database 120 for comparison with the output of the instance segmentation module (detected instance mask) may refer to the GT instance masks.

One image can include one or multiple instances.

In some implementations, the processor 130 can include an instance segmentation model and can train the instance segmentation model based on an image data set.

The processor 130 can compare the detected instance mask, the output of the instance segmentation model, with the corresponding GT instance mask to calculate the loss.

The processor 130 can apply the calculated loss to train the instance segmentation model to improve the performance of the instance segmentation model.

The processor 130 can include a training module 131 and a loss calculation module 132.

The training module 131 can include the instance segmentation model and train the instance segmentation model based on the input image dataset.

The instance segmentation model can detect instances in images through training and output the detected instance mask.

The loss calculation module 132 can calculate the loss based on the detected instance mask input from the training module 131 and the GT instance mask stored in the second database 120.

The loss calculation module 132 can calculate the loss by comparing the detected instance mask with the corresponding GT instance mask.

The loss calculation module 132 can calculate the newly proposed component-balance focal (CBF) loss by applying component-wise weights to the existing binary cross-entropy (BCE) loss.

The loss calculation module 132 can provide the calculated loss to the training module 131, enabling the training module 131 to train the instance segmentation model by reflecting the loss.

In some implementations, the loss (L_{CBF}) can be expressed as Equation 1.

$${L}_{C B F} = {\sum }_{p}^{A} {w}_{p}^{′} \cdot {l}_{b c e , p} \qquad [ Equation 1 ]$$

Here,

$${w}_{p}^{′}$$

can refer to the weight coefficient, wₐᵥ can refer to the mean coefficient uniformly applied to the entire mask area, l_{bce,p} can refer to the BCE loss for each pixel point p, and A can refer to the area of the component to which the pixel point p belongs.

The weight coefficient

$${w}_{p}^{′}$$

can be expressed as Equation 2 depending on whether the pixel point p is included in the background or in the foreground of the component.

$${w}_{p}^{′} = \{ \begin{matrix}{w}_{av} & if p ∈ background \\ {τ}_{i} \cdot {w}_{av} & if p ∈ {C}_{i} ( {i}^{th} component )\end{matrix} \qquad [ Equation 2 ]$$

For example, when the pixel point p is included in the background, the weight coefficient

$${w}_{p}^{′}$$

can be defined as the mean coefficient wₐᵥ uniformly applied to the entire mask area, and when the pixel point p is included in any component, the weight coefficient

$${w}_{p}^{′}$$

can be defined as τᵢ·wₐᵥ.

Here, τᵢ can refer to the component-wise weight, ensuring that the cumulative contribution of loss for each component is assigned equally regardless of the component's area.

The component-wise weight τᵢ can be defined as Equation 3.

$${τ}_{i} = \frac{\frac{1}{K} {\sum }_{j}^{K} {A}_{{C}_{j}}}{{A}_{{C}_{i}}} \qquad [ Equation 3 ]$$

Here, K can refer to the number of components, A_{C}_{ᵢ} can refer to the area of the ith component, and A_{C}_{ⱼ} can refer to the area of the jth component.

For example, assuming that there are two components (C1, C2) in the image, and the area of component C1 (A_{C}_{₁}) is relatively larger than the area of component C2 (A_{C}_{₂}) (A_{C}_{₁}>A_{C}_{₂}), the weight (τ₁) applied to component C1 and the weight (τ₂) component C2 can be calculated as follows:

$${τ}_{1} = \frac{\frac{1}{2} {\sum }_{j}^{2} {A}_{{C}_{j}}}{{A}_{{C}_{1}}} = \frac{\frac{1}{2} ( {A}_{{C}_{1}} + {A}_{{C}_{2}} )}{{A}_{{C}_{1}}} , {τ}_{2} = \frac{\frac{1}{2} ( {A}_{{C}_{1}} + {A}_{{C}_{2}} )}{{A}_{{C}_{2}}}$$

Equations 1 to 3 are applicable when processing the entire mask, however, the Component-Balance Focal (CBF) loss calculation method can also be applied to point-based loss calculation, which calculates the loss at sampled points.

In point-based loss calculation, the loss (L_{CBF}) may be calculated based on the modified equations, Equations 4 to 6, derived from Equations 1 to 3.

$${L}_{C B F} = {\sum }_{p}^{{N}_{points}} {w}_{p}^{′} \cdot {l}_{b c e , p} \qquad [ Equation 4 ]$$

$${w}_{p}^{′} = \{ \begin{matrix}{w}_{av} & if p ∈ background \\ {τ}_{i} \cdot {w}_{av} & if p ∈ {C}_{i} ( {i}^{th} component )\end{matrix} \qquad [ Equation 5 ]$$

$${τ}_{i} = \frac{\frac{1}{K} {\sum }_{j}^{K} {N}_{{C}_{j}}}{{N}_{{C}_{i}}} \qquad [ Equation 6 ]$$

In Equations 4 to 6, Nₚₒᵢₙₜₛ can refer to the number of sampled points,

$${w}_{p}^{′}$$

can refer to the weight coefficient, wₐᵥ can refer to the mean coefficient uniformly applied to the entire mask area, l_{bce,p} can refer to the BCE loss for point p, K can refer to the number of components, N_{C}_{ᵢ} can refer to the number of sampled points for the i^{th} component, and N_{C}_{ⱼ} can refer to the number of sampled points for the j^{th} component.

Here, τᵢ can refer to the component-wise weight, ensuring that the cumulative contribution of loss for each component is assigned equally regardless of the number of sampled points.

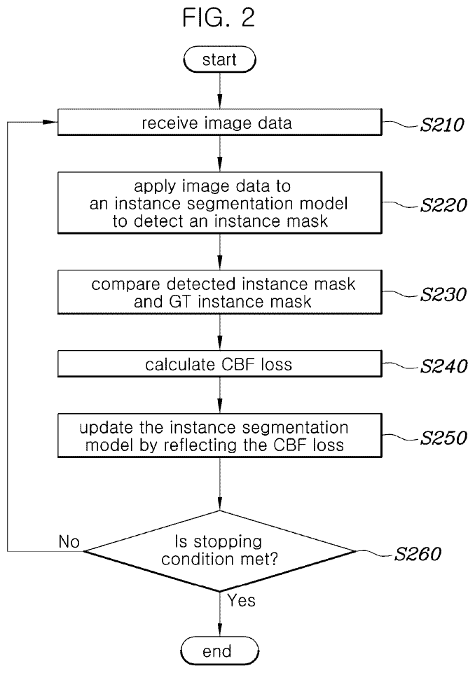

FIG. 2 is a flowchart illustrating an example of an instance segmentation model training method.

The stepwise operations depicted in FIG. 2 can be implemented by the processor 130 of the instance segmentation model training system 100 of FIG. 1.

With reference to FIG. 1 and FIG. 2, the processor 130 can receive image data at step S210 and apply the received image data to the instance segmentation model to detect an instance mask at step S220.

Sequentially, the processor 130 can compare the detected instance mask with the GT instance mask at step S230 and calculate the CBF loss based on the loss calculation method at step S240.

At step S240, when configured to calculate the loss based on the entire mask, the processor 130 can compute the CBF loss based on Equations 1 to 3.

At step S240, when configured to calculate the loss based on sampled points, the processor 130 can compute the CBF loss based on Equations 4 to 6.

Afterwards, the processor 130 can update the instance segmentation model by incorporating the CBF loss at step S250.

Afterwards, the processor can may determine whether the predefined stopping condition is met at step S260.

If the predefined stopping condition is met (S260—Yes), the processor 130 can stop training for the instance segmentation model. If the predetermined stopping condition is not met (S260—No), the processor 130 can perform steps S210 through S250 again. For example, the processor 130 can repeat steps 210 through 250 until the predefined stopping condition is met.

The stopping condition can be defined in a variety of ways depending on the application and/or model, and is not limited to the present embodiment of the disclosure.

For example, the stopping condition can include when the difference (or loss) between the detected instance mask and the GT instance mask is less than a predefined threshold, when the rate of change of the difference (or loss) between the detection instance mask and the GT instance mask is less than a predefined threshold, when the accuracy (or F1-score) of a performance evaluation metric is greater than a predefined threshold, when the instance segmentation model has been trained a predefined number of times, and so on.

Table 1 shows the results tested for the instance segmentation model trained using the implementations of features described in this application and the instance segmentation model trained according to conventional techniques.

TABLE 1

| | Application | | | | |
|---|---|---|---|---|---|
| Model | of CBF loss | APᵥₐₗ | ICAPᵥₐₗ | APₜₑₛₜ | ICAPₜₑₛₜ |
| QueryInst | X | 43.6 | 36.6 | 44.0 | 37.0 |
| QueryInst | ◯ | 45.5 | 38.1 | 45.6 | 38.1 |
| QueryInst(OCP⁺) | X | 44.1 | 37.2 | 44.9 | 37.8 |
| QueryInst(OCP⁺) | ◯ | 46.3 | 39.0 | 46.2 | 39.0 |
| Mask2Former | X | 55.3 | 47.1 | 55.3 | 46.9 |
| Mask2Former | ◯ | 56.8 | 49.1 | 56.9 | 49.1 |

The tests were conducted based on the OCHumanEX benchmark, an occluded human instance segmentation dataset.

It can be observed that the performance of the instance segmentation model applying the CBF loss according to implementations of the present disclosure is superior to that of other models. This performance improvement can be attributed to the enhancement in instance completeness due to the application of the CBF loss.

Therefore, it can be concluded that the instance segmentation model trained based on the CBF loss according to implementations of the present disclosure can outperform other existing models, demonstrating that the CBF loss is highly effective for implementing instance segmentation models.

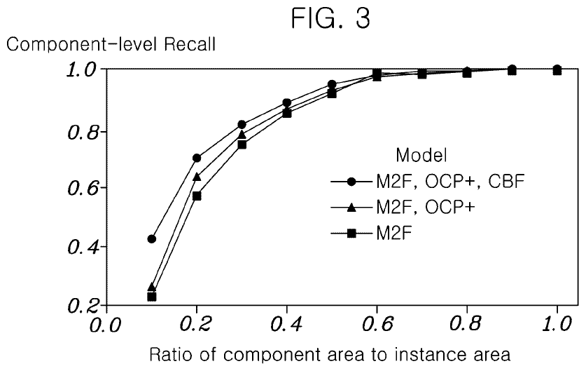

FIG. 3 is a graph representing an example of the component-level recall relative to the ratio of component area to instance area.

With reference to FIG. 3, it can be seen that recall is lower for smaller components compared to larger components.

When the CBF is applied loss according to implementations of the features described in this application, the recall performance of the instance segmentation model can improve.

Notably, applying the CBF loss can significantly improve the recall performance for both large and small components compared to conventional instance segmentation models. This demonstrates that the CBF loss is highly effective in improving instance completeness while ensuring that it does not compromise the segmentation performance for large components.

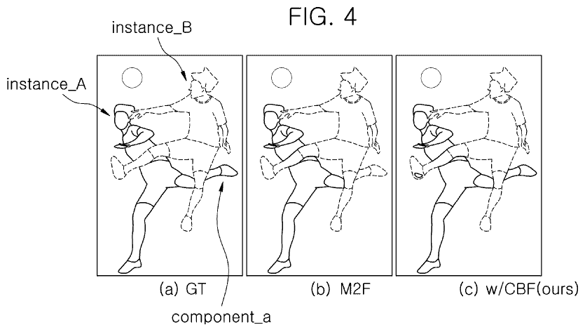

FIG. 4 is a diagram illustrating an example of a comparison between the training results of the instance segmentation model according to implementations of the present disclosure and the existing instance segmentation model with the ground truth (GT) instance mask.

In FIG. 4, (a) represents the GT instance mask, (b) represents the detected instance mask output by the conventional instance segmentation model, and (c) represents the detected instance mask output by the instance segmentation model according to implementations of the present disclosure.

With reference to FIG. 4, the conventional instance segmentation model misidentifies component_a of instance_A as a component of instance_B (b), while the instance segmentation model according to implementations of the present disclosure can correctly identify component_a as belonging to instance_A (c).

In some implementations, the processor 130 can be implemented as a hardware data processing device with a circuit having a physical structure to execute desired operations. For example, the desired operations can encompass codes or instructions included in the program.

For example, the hardware-implemented data processing device can encompass microprocessors, central processing units (CPUs), processor cores, multi-core processors, multiprocessors, application-specific integrated circuits (ASICs), and field programmable gate arrays (FPGAS).

The processor 130 can be configured to store data related to algorithms or software instructions that control the operation of various components related to the features of the disclosure in memory, and to execute the operations described herein using the data stored in the memory. Here, the memory and processor can be implemented as separate chips or integrated into a single chip.

For example, the memory can store various algorithms, data, and other information necessary for the operation of the processor 130. The memory can include volatile memory and/or non-volatile memory. The volatile memory can include dynamic random access memory (DRAM), static RAM (SRAM), synchronous DRAM (SDRAM), phase-change RAM (PRAM), magnetic RAM (MRAM), resistive RAM (RRAM), and ferroelectric RAM (FeRAM). The non-volatile memory can include read-only memory (ROM), programmable ROM (PROM), electrically programmable ROM (EPROM), electrically erasable programmable ROM (EEPROM), and flash memory.

What is claimed is:

1. An instance segmentation model training method comprising:
applying image data to an instance segmentation model to thereby detect an instance mask;
calculating a loss based on (i) the detected instance mask and (ii) a ground truth (GT) instance mask corresponding to the image data; and
updating the instance segmentation model based on the calculated loss,
wherein the loss is calculated by applying a component-wise weight to a binary entropy loss calculation formula.

2. The method of claim 1, wherein the weight is set based on a proportion of a component in the mask.

3. The method of claim 1, wherein the weight is (i) not applied to an area corresponding to a background and (ii) applied to an area corresponding to a component of an instance.

4. The method of claim 1, wherein the loss is calculated based on an entire mask or sampled points.

5. The method of claim 1, wherein the loss is calculated based on an entire mask, using Equation 1:
$${L}_{C B F} = {\sum }_{p}^{A} {w}_{p}^{′} \cdot {l}_{b c e , p} ,$$
where
$${w}_{p}^{′}$$
denotes a weight coefficient, l_{bce,p} denotes a binary cross entropy (BCE) loss for each pixel point p, and A denotes an area of a component to which a pixel point p belongs.

6. The method of claim 5, wherein the weight coefficient
$${w}_{p}^{′}$$
is calculated using Equation 2 and Equation 3:
$${w}_{p}^{′} = \{ \begin{matrix}{w}_{av} & if p ∈ background \\ {τ}_{i} \cdot {w}_{av} & if p ∈ {C}_{i} ( {i}^{th} component )\end{matrix} , \qquad [ Equation 2 ]$$
$${τ}_{i} = \frac{\frac{1}{K} {\sum }_{j}^{K} {A}_{{C}_{j}}}{{A}_{{C}_{i}}} , \qquad [ Equation 3 ]$$
where wₐᵥ denotes a mean coefficient uniformly applied to an entire mask area, τᵢ denotes the component-wise weight, K denotes a number of components, A_{C}_{ᵢ} denotes the area of the i^{th} component, and A_{C}_{ⱼ} denotes the area of the j^{th} component.

7. The method of claim 1, wherein the loss is calculated based on sampled points, using Equation 4:
$${L}_{CBF} = {\sum }_{p}^{{N}_{points}} {w}_{p}^{′} \cdot {l}_{bce , p} ,$$
where Nₚₒᵢₙₜₛ denotes a number of sampled point,
$${w}_{p}^{′}$$
denotes a weight coefficient, l_{bce,p} denotes a binary cross entropy (BCE) loss for each point p.

8. The method of claim 7, wherein the weight coefficient
$${w}_{p}^{′}$$
is calculated using Equation 5 and Equation 6:
$${w}_{p}^{′} = \{ \begin{matrix}{w}_{av} & if p ∈ background \\ {τ}_{i} \cdot {w}_{av} & if p ∈ {C}_{i} ( {i}^{th} component )\end{matrix} , \qquad [ Equation 5 ]$$
$${τ}_{i} = \frac{\frac{1}{K} {\sum }_{j}^{K} {N}_{{C}_{j}}}{{N}_{{C}_{i}}} , \qquad [ Equation 6 ]$$
where wₐᵥ denotes a mean coefficient uniformly applied to an entire mask area, τᵢ denotes the component-wise weight, K denotes the number of components, N_{C}_{ᵢ} denotes a number of sampled points for the i^{th} component, and N_{C}_{ⱼ} denotes a number of sampled points for the j^{th} component.

9. An instance segmentation model training system comprising:
a first database configured to store an image dataset;
a second database configured to store a ground truth (GT) instance mask set corresponding to the image dataset; and
a processor configured to:
apply image data to an instance segmentation model to thereby detect an instance mask,
calculate a loss based on the detected instance mask and a GT instance mask corresponding to the image data, and
update the instance segmentation model based on the calculated loss,
wherein the loss is calculated by applying a component-wise weight to a binary entropy loss calculation formula.

10. The system of claim 9, wherein the weight is set based on a proportion of a component in the mask.

11. The system of claim 9, wherein the processor is configured to (i) not apply the weight to an area corresponding to a background and (ii) apply the weight to points of an area corresponding to a component of an instance.

12. The system of claim 9, wherein the processor is configured to calculate the loss based on an entire mask or sampled points.

13. The system of claim 9, wherein the processor is configured to calculate the loss based on an entire mask, using Equation 1:
$${L}_{CBF} = {\sum }_{p}^{A} {w}_{p}^{′} \cdot {l}_{bce , p}$$
where
$${w}_{p}^{′}$$
denotes a weight coefficient, l_{bce,p} denotes a binary cross entropy (BCE) loss for each pixel point p, and A denotes an area of a component to which a pixel point p belongs.

14. The system of claim 13, wherein the processor is configured to calculate the weight coefficient
$${w}_{p}^{′}$$
using Equation 2 and Equation 3:
$${w}_{p}^{′} = \{ \begin{matrix}{w}_{av} & if p ∈ background \\ {τ}_{i} \cdot {w}_{av} & if p ∈ {C}_{i} ( {i}^{th} component )\end{matrix} , \qquad [ Equation 2 ]$$
$${τ}_{i} = \frac{\frac{1}{K} {\sum }_{j}^{K} {A}_{{C}_{j}}}{{A}_{{C}_{i}}} , \qquad [ Equation 3 ]$$
where wₐᵥ denotes a mean coefficient uniformly applied to an entire mask area, τᵢ denotes the component-wise weight, K denotes a number of components, A_{C}_{ᵢ} denotes the area of the i^{th} component, and A_{C}_{ⱼ} denotes the area of the j^{th} component.

15. The system of claim 9, wherein the processor is configured to calculate the loss based on sampled points, using Equation 4:
$${L}_{CBF} = {\sum }_{p}^{{N}_{points}} {w}_{p}^{′} \cdot {l}_{bce , p} ,$$
where Nₚₒᵢₙₜₛ denotes a number of sampled points,
$${w}_{p}^{′}$$
denotes a weight coefficient, l_{bce,p} denotes a binary cross entropy (BCE) loss for each point p.

16. The system of claim 15, wherein the processor is configured to the weight coefficient
$${w}_{p}^{′}$$
using Equation 5 and Equation 6:
$${w}_{p}^{′} = \{ \begin{matrix}{w}_{av} & if p ∈ background \\ {τ}_{i} \cdot {w}_{av} & if p ∈ {C}_{i} ( {i}^{th} component )\end{matrix} , \qquad [ Equation 5 ]$$
$${τ}_{i} = \frac{\frac{1}{K} {\sum }_{j}^{K} {N}_{{C}_{j}}}{{N}_{{C}_{i}}} , \qquad [ Equation 6 ]$$
where wₐᵥ denotes a mean coefficient uniformly applied to an entire mask area, τᵢ denotes the component-wise weight, K denotes a number of components, N_{C}_{ᵢ} denotes a number of sampled points for the i^{th} component, and N_{C}_{ⱼ} denotes a number of sampled points for the j^{th} component.
